(19) United States
(12) Patent Application Publication
(10) Pub. No.: US 2009/0235814 A1
(43) Pub. Date: Sep. 24, 2009

(54) Mobile Reconfigurable Barricade

(76) Inventors: Arthur H. Cashin, Nashville, TN (US); John J. Herbst, Nashville, TN (US); John Martin, Wiltshire (GB)

Correspondence Address: WADDEY & PATTERSON, P.C., 1600 DIVISION STREET, SUITE 500, NASHVILLE, TN, 37203, US

(21) Appl. No.: 12/188,295

(22) Filed: Aug. 8, 2008

Related U.S. Application Data
(63) Continuation-in-part of application No. 12/053,966, filed on Mar. 24, 2008.

(51) Int. Cl. F41H 5/16; F41H 5/00; B32B 7/00

(52) U.S. Cl. 89/36.02; 89/36.07; 428/73

(57) ABSTRACT

A mobile reconfigurable barricade having a plurality of cells comprised of multiple sheets of deformable barricading fabric. The deformable fabric permits one or more of the cells to collapse to create a bent or reconfigured barricade.

### CROSS-REFERENCE TO RELATED APPLICATIONS

This application is a continuation-in-part application which claims benefit of co-pending U.S. patent application Ser. No. 12/053,966 filed Mar. 24, 2008, entitled “BALLISTICS BARRIER” which is hereby incorporated by reference.

### TECHNICAL FIELD

The present invention relates to configurable and/or re-configurable mobile barricades. More specifically, the present invention pertains to barricades that can resist ballistics assaults and blast waves created from the detonation of explosives, the barricade being readily transportable and permitting in-situ configuration according to the demands of the operating environment.

### BACKGROUND OF THE INVENTION

Mobile barricades have utility, and may in fact be indispensable, in many disparate scenarios and environments. Of particular import are barricades that can be transported by a single individual, can be quickly deployed, and can be configured to suit to the circumstances requiring the barricade's use. For instance, a barricade possessing the aforementioned attributes is invaluable in applications ranging from municipal police use, to levee construction (or other civil engineering uses), to reconnaissance missions, to planned militaristic operations. The latter two applications have unique demands.

Consider that many military operations occur in remote localities or localities that do not offer the infrastructure needed to defend against ballistics assaults. Further consider that military personal must often carry everything that they will need during a deployment on their person. Thus, any barricade that will be used must be lightweight, compact, easily set-up, and afford significant protective capabilities against a wide range of enemy assaults. Additionally, the barricade must adapt to the terrain, the situation, and the needs of the individual employing the barricade.

For example, a barricade may need to provide protection on more than one front. Thus, if enemy fire is emanating from two distinct positions, an effective barricade must be able to configure/re-configure to provide protection against both positions. Further, a barricade should also accommodate irregularities in surface topology so that the barricade can be deployed without the need to locate an ideal position, a luxury not often permitted in combative settings. The prior art has proffered a plethora of barricades to meet the above needs.

U.S. Pat. No. 6,581,505 issued to Levell discloses a portable barricade having two main components, a collapsible ladder and a ballistics shield blanket. In operation, the collapsible ladder is first extended to its full length. Next, the blanket is unfolded and secured, via straps, to the ladder. The blanket spans the length and width of the extended ladder. Preferably, the blanket is made from a material resistant to projectiles such as KEVLAR®. The blanket may also have one or more pockets that are configured to accept ballistics panels that further enhance the protective attributes of the barricade.

U.S. Pat. No. 6,807,890 issued to Fuqua describes a portable ballistics shield. The shield includes multiple sections that are foldably connected together. The foldably connected sections can be extended to form the protective shield. Further, the foldably connected sections permit the shield to collapse into a smaller form factor amenable to transportation and storage. To cover any gaps between the foldably connected sections, the shield provides one or more overlapping fabric panels extending across the gaps between the sections. The shield sections are fabricated from a ballistics material such as KEVLAR® or SPECTRA®.

U.S. Pat. No. 5,939,658 issued to Muller discloses a shield system for structures having windows and/or doors. Specifically, the shield system includes a securing strip positioned above the window or door and a ballistics curtain that can be attached to the securing strip to allow the curtain to drape over the window or door. The ballistics curtain is made from a fabric that resists ballistics assaults, such as GOLDSHIELD™ and GOLDFLEX™.

The use of sandbags to form configurable barricades is also well known in the prior art. Unfilled sandbags are portable and inexpensive. However, the use of sandbags to construct a barricade is not without drawbacks. For instance, filling the sandbags is a labor-intensive process; typically one person holds the sandbag open while another person manually fills the bag. Further, time and effort must be dedicated to moving and arranging each individual sandbag to form a shelter. As with any barricade constructed from non-interconnected components, sand bag barriers have numerous failure points—weakness at any of the sandbag-to-sandbag interfaces. Lastly, sandbags lack the robustness needed to construct an effective barricade, i.e. they are easily torn or otherwise damaged.

Thus, what is needed is a light-weight, configurable, and readily portable barricade that can leverage in-situ materials and terrain to provide an effective shelter from explosions and/or ballistics assaults.

### SUMMARY OF THE INVENTION

The present invention discloses a barricade capable of being transported and erected by a single person, is in-situ configurable, and can defend against multiple fronts to provide protection against both blast waves and ballistics assaults. The inventive barricade has an open cellular structure having at least first, second, and third cells. The barricade, and therefore the cells, is formed from deformable barricading fabric, which may be a geotextile-based fabric. Preferably, the barricade is formed from multiple sheets of barricading fabric mechanically fastened together to define the cellular structure. Once deployed, the open cells of the barricade can be packed with fill material, such as soil, sand, or rocks. As the range of fill material accepted by the present invention is so diverse, typically, the fill material can be located proximate the erection site (thereby avoiding the requirement to carry heavy fill material).

Further, packing the cells can be expedited by utilizing a front end loader, a back hoe, a conveyor apparatus, or the like. Because the barricade is an assembly of open interconnected cells, and the barricading fabric is self-supporting, large amounts of fill material may be deposited in multiple cells at once with a single effort. Additionally, a light-weight rigid framework may be employed to facilitate the filling process. Such a framework may be coextensive with the perimeter of the barricade and couple to some or all of the cells comprising the barricade's perimeter. This would allow the framework to provide tension across the plurality of cells to encourage the cells into their most exposed, i.e. open, position thereby facilitating the packing/filling process. Further, the framework may be constructed from a set of readily transportable rods or constituent members that interconnect to form the composite framework. Alternatively, the framework may be sized to hold open a single cell. Such a frame would be compact yet provide a single individual with the ability to easily transport and deploy the frame. However, the present invention is not limited to the frames described herein, the present invention also envisions any technique or apparatus that opens the cells to aid in packing, e.g. tensioning opposing corners/sections of the barricade by manual effort or tie downs. Compared with the individualized packing process associated with, for instance, prior art sandbags, the present invention permits a mass packing effort—thereby significantly reducing the time required to construct the barricade.

Because the barricade is defined by sheets of deformable barricading fabric and packed with in-situ fill material, the barricade can be collapsed and arranged into a light-weight form factor amenable to transportation, especially by a single person. Further, the construction and materials used to fabricate the barricade, which give the barricade the ability to deform/collapse, also engender the barricade with the ability to be readily configured.

The barricading sheet(s) may be a high strength fabric, either woven or non-woven. If woven, the present invention envisions any weave and natural or synthetic threads or yarns. If non-woven, any non-woven technology or polymer which meets a minimum of 100 lbs grab tensile (or grab tensile strength as determined by test method ASTM D4632) with a preferred range of above 300 lbs grab tensile (including woven materials, collectively referred to a “barricading fabric” or “barrier fabric” herein after). Preferably, the fabric is a polypropylene-based, non-woven geotextile material. Such a material is known to be puncture and tear resistant, flexible, possess a high tensile strength, and to be stiff enough to form, and maintain, a framework without the aid of any external braces or supports, especially important for avoiding the creation of shrapnel or other flying debris. TYPAR®, manufactured by Fiberweb, Inc. is one such material. One desirable aspect of TYPAR material is that it has a high TEA (total energy absorbed) per unit weight, especially as compared to materials such needle-punched fabrics which may have comparable tensile strengths. However, in addition to those mentioned above, other materials are also envisioned by the present invention, these materials include non-polypropylene based non-wovens, composite wovens, HDPE (high-density polyethylenes), polyethylene terephthalate, KEVLAR® material, and scrims reinforced fabrics.

In one embodiment, the present invention includes a first cell flanked on one side by a second cell and on the other side by a third cell; to form a row of cells. Each of the first, second, and thirds cells (or compartments) is defined by a plurality of vertical walls with an open top and bottom, once the barricade is in a deployed position. The vertical walls of the cells may be formed from three sheets of barricading fabric; a first sheet defining a front wall, a second sheet defining a back wall, and a third sheet defining the internal walls separating the cells. Resultantly, the anterior portions of the first, second, and third cell are part of the back wall. If the anterior portion of the first cell is collapsed or folded, then the anterior portions of the second and third cells will adjoin or, at least, move towards each other. Assuming no other adjustments are made to the barricade, the collapsing of the anterior portion of the first cell, and the subsequent shift in the position of the second and third cells, will “bend” the barricade. Thus, when deployed the cells of the barricade may be in a relatively straight line, however, once the first cell is collapsed the cells of the barricade may be arranged in a “V” or “bent” pattern.

With the barricade assuming a bent topology, the barricade can now provide protection from assaults initiated from multiple points of attack. It should also be noted that the present invention allows the non-linear cell arrangement to be formed from a single barricade. This permits the present invention to provide a bent topology without sacrificing the structural integrity owing from a unitary construction. While it may be possible to take several individual barricades from the prior art and arrange them to form a bent barricade network, this prior art composite barricade will have structural weaknesses at the joints between the individual barricade units. Moreover, it will now be readily apparent to one of ordinary skill in the art that barricades of the present invention comprised of many cells can assume numerous configurations by collapsing one or more cells, a task easily accomplished during erection.

No less important than the ability of the barricade to be arranged/configured to repel assaults emanating from different angles, is the barricade's ability of effectively dissipate the energy from a projectile (including the projectile itself) and/or a blast wave from an explosive device. The present invention serves to protect persons from ballistics assaults and blast waves through two primary mechanisms. Firstly, the fill material dissipates the kinetic energy of the projectile or blast wave as it travels through the fill material and the barricading fabric defining the cell walls. Secondly, the cellular arrangement of the invention provides walls that function as shear absorbing boundaries as they are acted upon by the advancing blast waves, scatters the blast waves, and provides a medium through which reflected waves may travel and dissipate. As will be discussed below, the ability to dissipate the blast waves by way of attenuation and scattering is of paramount concern in barricades.

When a projectile and/or a blast wave from an explosion strikes the barricade, pressure waves are created that travel through the barricade (from the front to the back relative to the projectile's initial engagement with the barricade). The blast or pressure waves are attenuated by the fill material. However, the fill material transmits a portion of the forces created by the pressure waves to the fabric interface, e.g. the barricading fabric, between the cells. The fabric interface both dissipates and scatters/redirects the pressure wave. The barricading fabric material (such as TYPAR) dissipates the pressure wave because the barricading fabric is a shear-absorbing material. Thus, as the pressure waves encounter the cell walls a significant portion of pressure wave energy is absorbed by the barricading fabric. Further, as a result of the cellular structure and arrangement of the present invention, the cell walls also serve to interrupt and redirect the pressure waves as they travel through the barricade. In summary, the barricade, via the arrangement and composition of the cells, both absorbs and redirects incident pressure waves (this is in addition to the attenuating effects of the fill material in the cells). In the case of a projectile striking the barricade, the present invention encourages the projectile to fragment (by the projectile's interaction with the fill material). This fragmentation serves to dissipate the penetrating capabilities of the projectile.

If a residual pressure wave reaches the fabric at the back of the barricade, there will be no relatively dense fill material on the other side of the interface for the blast wave to travel through. When this occurs, the pressure wave impacts and distorts/deforms the fabric itself. To effectively manage this situation, the fabric must have sufficient tensile strength to absorb this force and reflect it back in the opposite direction as a tensile stress wave. If the cellular structure were not there to accept and reflect the forces then the energy carried by the pressure wave would completely dissipate when it encountered the back of the barricade. This dissipation is manifested in the form of a dynamic energy release. Such an energy release can be very destructive. The spalling of the back side of a concrete wall as a result of an impact to the front side is one such manifestation of this type of destructive energy release. However, merely reflecting the tensile stress wave does not alleviate the problem. There must also be a conduit through which the tensile stress wave can travel back through the barricade. In most applications, the fill material will not readily accept the tensile wave. Advantageously, the barricading fabric defining the cells will readily accept the tensile wave and allow the wave to travel back through the barricade and further dissipate.

Consequently, it is desired to have a barricade to accept, reflect, and dissipate the forces generated from an explosion or ballistics assault. The barricading fabric serves this role in the invention. Thus, the present invention dissipates the kinetic energy of the projectile and/or explosion and provides a medium through which blast waves may travel, and hence dissipate. In this way, the present invention effectively suppresses the damage caused from a ballistics assault or explosion.

Although the above discussion has focused on the use of the present invention in combat settings, the present invention also has numerous non-combat applications. One such application field is civil engineering. For instance, the present invention has utility in levee construction/fortification. The present invention is well suited for these types of applications because it can be quickly erected (and packed with fill material in a mass effort such as with a conveyor, back hoe, or other heavy equipment). Further, because of the present invention's configurable nature and flexible construction from barricading fabric, it can conform to irregular surface topologies and/or be arranged in a zigzag to provide increased stability to resist water overflow and debris impact.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operations of the invention.

### BRIEF DESCRIPTION OF THE DRAWINGS

FIGS. 1a-1c are top views of one embodiment of the present invention illustrating the sequence of configuring the present invention into a “bent” arrangement.

FIG. 2 is an exploded top view of one embodiment of the present invention.

FIG. 3 is top view of one embodiment of FIG. 4a being collapsed.

FIGS. 4a-4c are top views of another embodiment of the present invention illustrating the sequence of configuring the present invention into a bent arrangement.

FIG. 5 is a top view of yet another embodiment of the present invention in a bent arrangement.

FIG. 6 is an exploded cross-sectional view of a portion of the present invention of FIG. 7 along line Z.

FIG. 7 is a top view of still another embodiment of the present invention illustrating the primary, first and second triangular compartments.

### DETAILED DESCRIPTION OF THE PREFERRED EMBODIMENTS

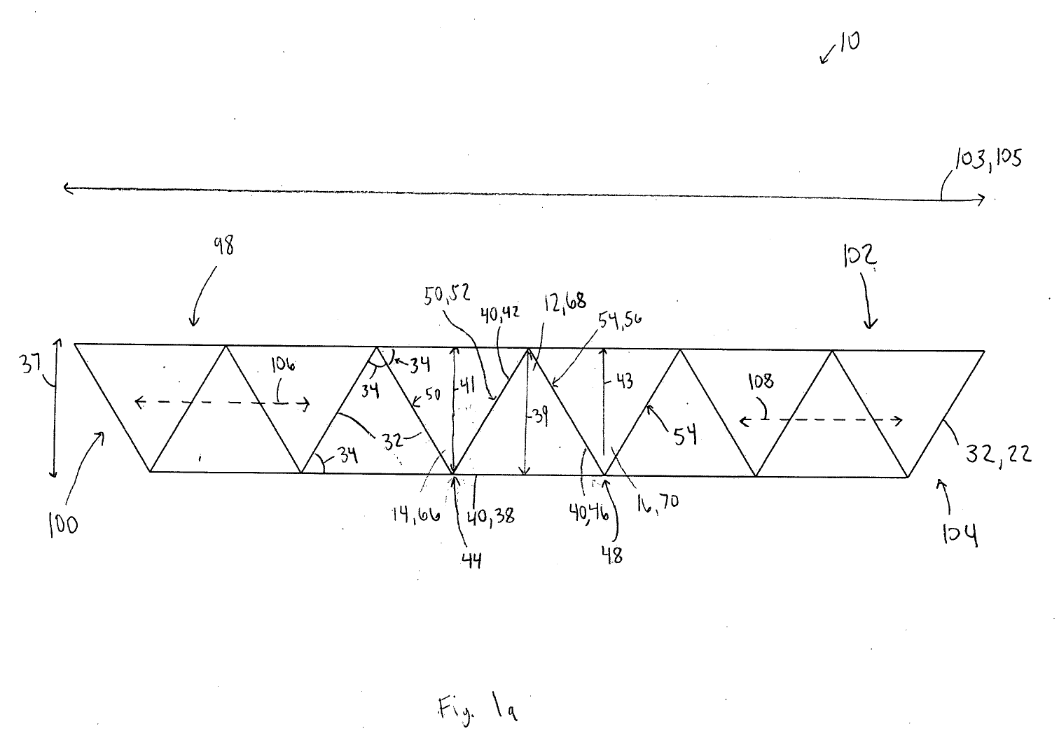

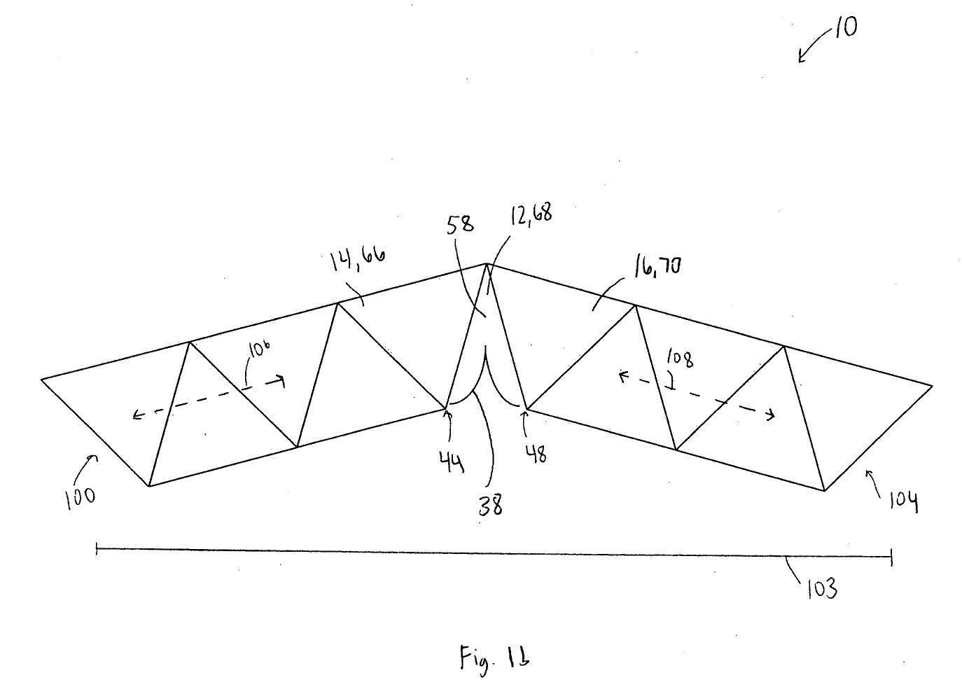

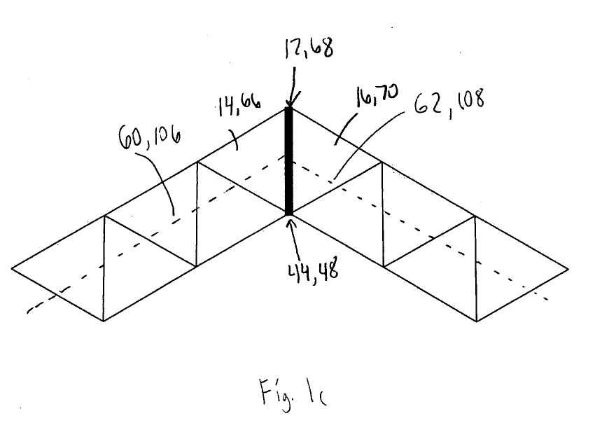

The present invention relates generally to mobile barricades and more particularly to configurable/re-configurable mobile barricades that can be transported by a single person. The present invention provides a mobile barricade 10 or a protective barrier 10 having a primary cell 12, a first cell 14, and a second cell 16, as shown in FIG. 1. The barricade 10 may have additional cells, cell sizes, or cell shapes depending on the desired overall length of the barricade 10 and/or other strictures such as those dictated by end use and manufacturability considerations. For instance, FIG. 1a depicts a barricade 10 with eleven cells.

The barricade 10, and the cells more particularly, are formed from deformable barricading fabric, also referred to as collapsible barrier fabric. This fabric occupies a vital role in the performance of the present invention. The fabric may be a woven, knitted, or non-woven fibrous web. In one preferred embodiment, the fabric is a polypropylene-based non-woven geotextile material. Although, the geotextile may comprise about 60% to about 80% polypropylene and about 20% to about 40% polyethylene, the geotextile of one preferred embodiment, is comprised entirely from polypropylene (exclusive of impurities). One such material is TYPAR, available from Fiberweb Inc. of Old Hickory, Tenn.

TYPAR is a high strength non-woven fabric manufactured using highly oriented individual polyolefin fibers. Desirably, these fibers are between about three and thirty Denier (a unit of weight indicating the fineness of fiber filaments) and even more desirably between about eight and twenty-two Denier. This composition would imbue the geotextile with resistance to naturally occurring soil alkalis and acids (of great import if the fill material is soil). Additionally, the geotextile would be unaffected by bacteria or fungi. Because, in most applications, the geotextile will be exposed to sunlight, and its harmful ultraviolet (UV) radiation, the geotextile may be made from fibers that contain ultraviolet and anti-oxidant additives or be coated with an UV resistant coating to improve the life of the material. As it is often desirable for a barricade to be camouflaged, the geotextile is receptive to pigmentation, coloring, and dying. Thus, the present invention envisions a camouflaged barricade that reduces the visual footprint of the barrier. The camouflaged pattern may be matched to the environment in which the barricade will be deployed.

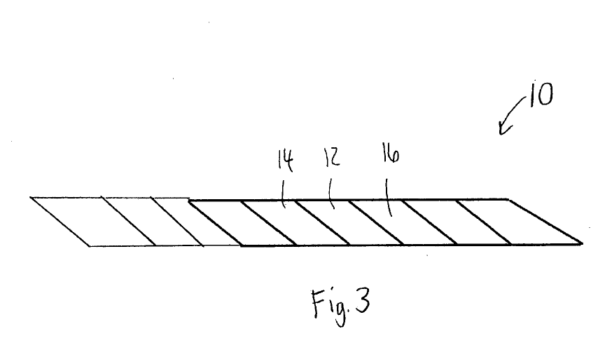

Advantageously cells constructed in the above-described manner are laterally collapsible. Consider that the cells are formed from a non-rigid fabric and the formation of the cells is only a consequence of the bonding of sheets of fabric together at certain points. Because the fabric is pliable and no rigid framework supports the barricade 10, the barricade 10 may be collapsed as shown in FIG. 3. After the barricade 10 has been laterally collapsed, it may also be manipulated into a different form-factor, e.g. the barricade 10 may be rolled or folded into a form-factor more amenable to transportation or storage, often referred to as a low logistical footprint. In one preferred embodiment, the barricade 10 has a volume ratio, the ratio of an erected, filled barricade to that of a collapsed and packaged barricade, from about 40:1 to 100:1, with the preferred ratios ranging from approximately 70:1 to 100:1.

Moreover, a typical single unit, fabricated in accordance with the present invention, could provide a barricade about five meters long, about one meter wide and one-half meters high. Further, such a barricade can weigh ten pounds or less (unfilled) depending on the material used—very manageable for a single person to transport, even across rugged terrain. However, units of varying sizes (e.g. longer, shorter, or with a greater height) are within the scope of the invention.

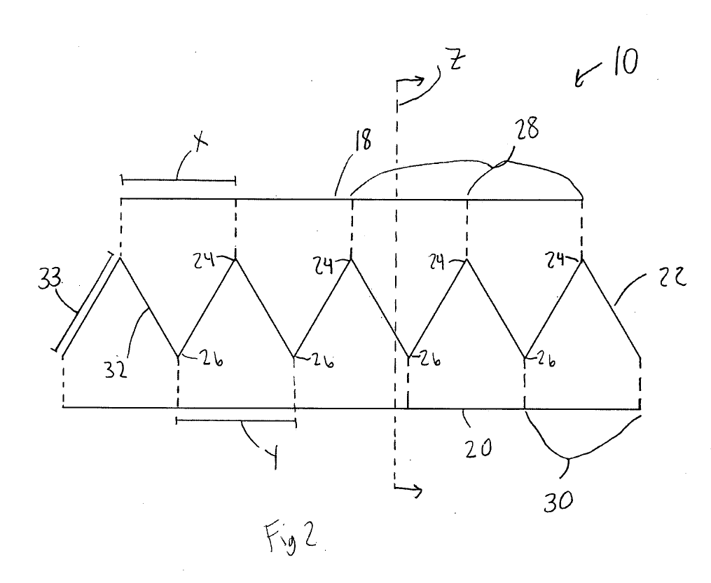

For illustrative purposes, consider FIG. 2, an exploded illustration of a barricade 10 having a first sheet of barricading fabric 18 defining a first exterior side 18, a second sheet of barricading fabric 20 defining a second exterior sheet 20, and a third sheet of barricading fabric 22 defining an interior sheet 22 or interior divider 22. The arrangement of the interior sheet 22 is exaggerated to highlight the role it plays in barricade 10. The interior sheet 22 has first interior vertices 24 that are fastened to the first exterior sheet 18 at first attachment points 28, spaced by an interval X. The interior sheet 22 also has second interior vertices 26 that are fastened to the second exterior sheet 20 at second attachment points 30, spaced at interval Y. This configuration results in the barricade 10 similar to that shown in FIG. 1a, a barricade with triangular-shaped cells, with interior cell walls 32 and interior cell angles 34.

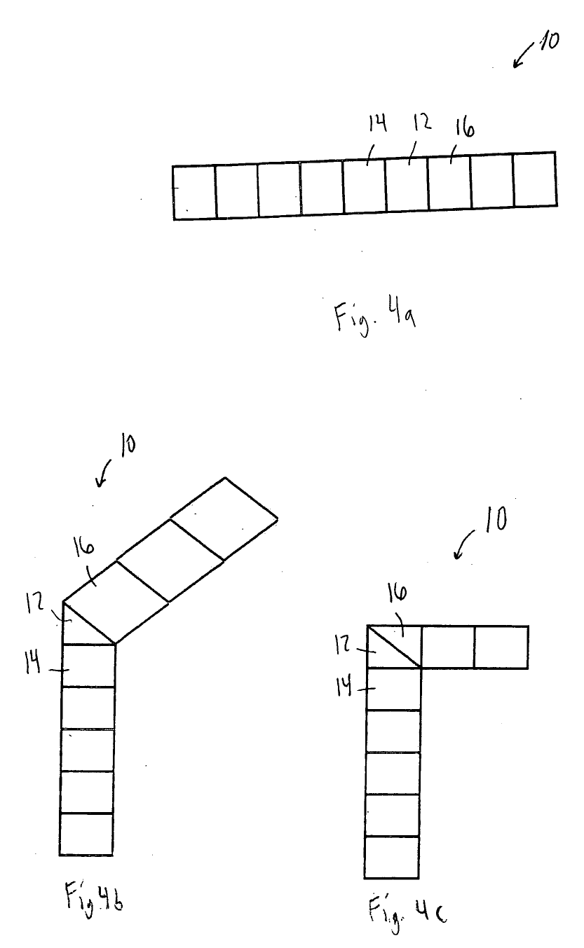

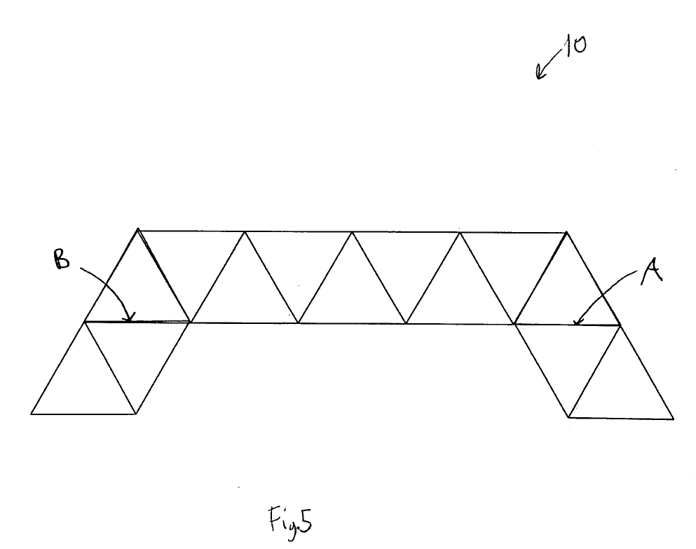

It will now be obvious to one of ordinary skill in the art that more cells can be added and that the cell shape and size can be altered by, for example, varying the interior cell angles 34, the length of the interior cell walls 33, and the intervals X and Y. Thus, the dimensions of the resulting barricade can be manipulated to achieve a desired size and/or shape. Further, by altering the above-recited variables other cell configurations are within the scope of the invention, such as rectangular-shaped cells seen in FIGS. 4a-4c. Although the sheets 18, 20, and 22 can be attached in a plethora of ways (such as by adhesives, staples, pins, retaining clips, etc.), the preferred method is by sewing. This type of construction also provides that the width of the barricade 37 will not be greater than the widths of any of the primary cell 39, the first cell 41, or the second cell 43, this allows for a compact yet effective barricade design.

Although the preferred embodiment of the present invention utilizes multiple sheets of fabric, similar cell structures could also be made from a continuous sheet of barricading fabric. This could be accomplished by folding the fabric back and forth on itself and bonding the opposing segments at predetermined intervals.

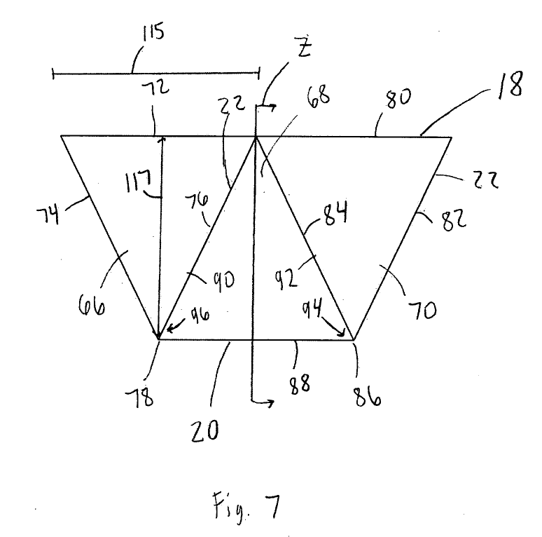

It may also be desirable for the barricade 10 to have an outer lip or skirt 36, as shown in FIG. 6. One way to create an integral skirt 36 is to provide the first and second exterior sheets 18 and 20 with heights greater than the interior sheet 22. After assembly, this height difference 53 provides a skirt 36 around the perimeter of the barricade 10, or at least a significant portion of the barricade 10. A skirt 36 has many beneficial attributes. For instance, the skirt 36 could act as a retaining wall for the fill material in the cells, i.e. it could present a barrier to the fill material escaping. Additionally, if one barricade is vertically stacked on another, the skirt 36 could overlap the bottom of the upper most barricade and prevent fill material deposited in the uppermost barricade from leaking out at the barricade-to-barricade joint.

Now that the barricading fabric and the construction of the barricade 10 have been expounded upon, a closer examination of the cells 12, 14, and 16 and the reconfigurable nature of the barricade 10 is in order. Referring to FIG. 1a, the primary cell 12 may have a plurality of primary cell walls 40. The number of primary cells walls 40 depends on the shape of the primary cell 12; e.g. three cell walls for a triangular cell, four cell walls for a rectangular cell, etc. Of the plurality of primary cell walls 40, one is a connecting side wall 42 with a connecting edge 44, and one is a coupling side wall 46 with a coupling edge 48. The primary cell 12 has an anterior portion 38 extending between the connecting edge 44 and the coupling edge 48. The anterior portion 38 may be defined by one or more of the plurality of primary cell walls 40.

The first cell 14 includes a plurality of vertically oriented first cell walls 50 with one of the plurality being a first side wall 52. The second cell 16 includes a plurality of vertically oriented second cell walls 54 with one of the plurality being a second side wall 56. The arrangement or topology of the primary, first, and second cells 12, 14, and 16 can be described as the connecting side wall 42 engaged to the first side wall 52 and the coupling side wall 46 engaged to the second side wall 56. It should be noted that in a preferred construction of the present invention, the single interior sheet 22 defines the interior walls 32, which generally describe the connecting side wall 42, the coupling side wall 46, the first side wall 52, and the second side wall 56. However, in alternative embodiments multiple interior sheets may define the interior walls 32. Thus, the engagement between the coupling side wall 46 and the second side wall 56 and the connecting side wall 42 and the first side wall 52 can embody either two sides of the same wall (if one interior sheet is used in the construction) or two distinct walls (if more than one sheet is used to create the primary, first, and second cells 12, 14, and 16).

As a natural result of the construction, i.e. the cellular arrangement, and material employed to define the barricade 10, the anterior portion of the primary cell 38 may be collapsed by encouraging the connecting edge 44 and the coupling edge 48 towards each other as seen in FIG. 1b. The collapsed or folded anterior portion 38 my move into the body of the primary cell 58 or project outside the extent of the barricade 10. As the anterior portion 38 is collapsed, the first and second cells 14 and 16 will rotate relative to the primary cell 12 resulting in a bent configuration as seen in FIG. 1c or a “V” shape. That is after collapse, the first cell 14 will occupy a first longitudinal axis 60 in a first direction and the second cell will occupy a second longitudinal axis 62 in a second direction, also shown in FIG. 1c. In some embodiments, only one of the first or second longitudinal axes 60 or 62 will change after the collapse relative to their pre-collapsed orientation. Even though FIG. 1c depicts the primary cell 12 as completely collapsed, the present invention also envisages a partially collapsed primary cell 12. The degree to which the primary cell 12 is collapsed determines, in part, the severity of the bend in the barricade 10.

More broadly described, and again referring to FIG. 1a, the barricade 10 may be a plurality of contiguous cells (such as 12, 14, and 16), the barricade 10 having a first end portion 98 with a first end 100 and a second end portion 102 with a second end 104. The first and second end portions 98 and 102 may encompass one cell or a groups of cells at the far ends of the barricade 10 and the first and second ends 100 and 104 may describe the cells defining the ends of the barricade 10. The first end portion 98 is aligned along a first axis 106 and the second end portion 102 is aligned along a second axis 108.

When completely unfurled, the barricade 10 has a length 103 measured between the first and second ends 100 and 104 and a maximum length 105 when the first and second axes 106 and 108 are axially aligned or, equivalently, collinear. The length is measured along a straight line extending between the first and second ends 100 and 104. The barricade 10 may be configured/re-configured from the axially aligned arrangement, mentioned above, by collapsing or partially collapsing one or more cells to reduce the volume of the one or more cells, such as the primary cell 12 shown in FIG. 1b. This causes one or both of the first and/or second axes 106 and/or 108 to change orientation, or become misaligned, and results in the barricade 10 having a length 103 less than the maximum length 105. Intuitively, as more cells are collapsed, and the resultant bends created in the barricade 10, the shorter the length of the barricade 10.

This above description of the collapsing process results in a barricade that can be configured/re-configured to suit the needs of the individual deploying the barrier and is applicable to myriad different cell shapes. The following will provide a detailed description of the reconfiguring process specifically focused on a triangular cell shape, which has several attractive attributes such as, but not limited to, inherent geometric strength and ease of manufacture.

Now referring to FIG. 7, the barricade 10 includes a first triangular compartment 66, comparable to a first cell 14, a central triangular compartment 68, comparable to the primary cell 12, and a second triangular compartment 70, comparable to the second cell 16. The first triangular compartment 66 comprises a first base wall 72, a first exterior wall 74, a first interior wall 76, a first apex 78 defined by the intersection between the first interior and exterior walls 76 and 74, and a first orientation. The second triangular compartment 70 comprises a second base wall 80, a second exterior wall 82, a second interior wall 84, a second apex 86 defined by the intersection between the second interior and exterior walls 84 and 82, and has the first orientation.

The central triangular compartment 68 comprises a central base wall 88 with a distal end 94 and a proximal end 96, a proximal wall 90, a distal wall 92, and a central orientation opposite the first orientation (i.e. the central base wall 88 is opposite the first and second base walls 72 and 80). The distal end 94 is connected to the distal wall 92 and the proximal end 96 is connected to the proximal wall 90. Further, the first interior wall 76 is engaged to the proximal wall 90 and the second interior wall 84 is engaged to the distal wall 92. As before, the first interior wall 76 and the proximal wall 90 may simply be opposing sides of a single sheet of barricading fabric. The same relationship is also applicable to the second interior and the distal wall 92. The barricade 10 can be configured/re-configured by collapsing or folding the central base wall 88 to cause the first and/or second triangular compartments 66 and/or 70 to pivot relative to the central triangular compartment 68.

The maximum bend or bend angle that can be achieved by collapsing any one cell or compartment is governed by the base-to-height ratio. For instance, the base-to-height ratio of a triangular compartment is the ratio of the length of the base wall 115 (e.g. first, second, or third base walls 72, 80, and 88) to the height of the triangular compartment 117; the distance between the base wall and the apex of the triangular compartment (e.g. first, second, or central apexes 78, 86, and 110), as shown in FIG. 7. Any particular bend angle between no bend and the maximum bend allowed by the base-to-height ratio can be achieved by partially filling the cell. The preferred base-to-height ratio is between about 0.25 to about 4, and even more specifically between about 0.75 to about 1.5.

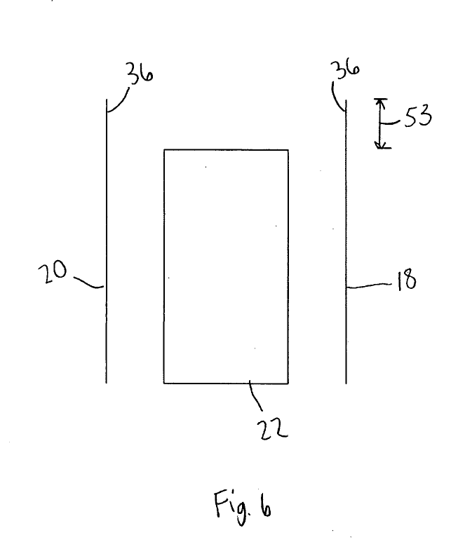

It is also possible to collapse multiple cells or compartments to create a more severe bend than that possible with only one cell. For instance, FIG. 4a shows a straight barricade with quadrilaterally-shaped cells, FIG. 4b shows the barricade 10 with a first degree of bend (caused by the collapse of cell 12), and FIG. 4c depicts the barricade with a second degree of bend (caused by collapsing adjacent cells 12 and 16). FIG. 5 depicts a barricade 10 with multiple non-adjacent cells collapsed to create a “U” shaped barricade. Specifically, cells A and B are completely collapsed.

In one embodiment, the triangular compartments 66, 68, and 70 are formed from three sheets of barricading fabric, as discussed above. Specifically, the first and second base walls 72 and 80 are formed from a first exterior sheet 18, or first sheet 18 and the central base wall 88 is formed from a second exterior sheet 20 or second sheet 20. The first exterior wall 74, the first interior wall 76, the proximal wall 90, the distal wall 92, the second exterior wall 82, and the second interior wall 84 are formed from a third sheet 22 or interior sheet 22. Thus, such a construction can create a barricade with triangular compartments that is easy to manufacture while consuming minimal raw material.

Regardless of the particular embodiment, the barricade 10 can be packed (assuming the barricade 10 has been unfurled from its compact, portable-friendly form factor) with fill material either before or after the barricade 10 has been bent, i.e. re-configured. The normal way to fill such a unit is to start from one end and work towards the other. In the situation where a bend is to be made in the wall, filling should stop 1 cell before the cell or cells to be collapsed. Once the empty cells are collapsed to give the desired bend, the first cell on the far side of the bend is filled to stabilize the geometry, and then any partially collapsed cells in the bend are filled. The balance of the unit is then filled. In the situation where two or more units are to be placed end to end, the same general technique is used, the next to the last cell in unit one and the second cell in unit two are filled to stabilize the joint then the two end cells are filled to maintain the same general cell shape as is found in the central part of any unit. This filling method is provided to help understanding, and is an example only. Other filling/packing methods that accomplish the same end are envisioned by the present invention.

All cited patents, patent applications and publications referred to herein are incorporated by reference.

Thus, although there have been described particular embodiments of the present invention of a new and useful Mobile Reconfigurable Barricade, it is not intended that such references be construed as limitations upon the scope of this invention except as set forth in the following claims.

What is claimed is:

1. A reconfigurable mobile barricade, comprising:
a primary cell having an anterior portion, wherein the primary cell includes a plurality of vertically oriented primary cell walls comprising deformable barricading fabric with one of the plurality of primary cell walls being a connecting side wall with a connecting edge and another of the plurality of primary cell walls being a coupling side wall with a coupling edge, and wherein the anterior portion is engaged to and extends between the connecting edge and the coupling edge;
a first cell comprising a plurality of vertically oriented first cell walls comprising deformable barricading fabric with one of the plurality of first cell walls being a first side wall;
a second cell comprising a plurality of vertically oriented second cell walls comprising deformable barricading fabric with one of the plurality of second cell walls being a second side wall; and
wherein the connecting side wall is engaged to the first side wall and the coupling side wall is engaged to the second side wall to define an elongated barrier structure, and further wherein, as a result of the deformable barricading fabric, the anterior portion can be collapsed when the connecting edge and the coupling edge are encouraged towards each other to cause the elongated barrier structure to occupy, via the first cell, a first longitudinal axis extending in a first direction and, via the second cell, a second longitudinal axis extending in a second direction different than the first direction.

2. The barricade of claim 1, wherein the primary cell has a primary width, the first cell has a first width, the second cell has a second width, and the elongated barrier has a width no greater than any of the primary, first, and second widths.

3. The barricade of claim 1, wherein the connecting side wall and the first side wall are formed from a signal sheet of barricading fabric.

4. The barricade of claim 1, wherein the deformable barricading fabric comprises a geotextile.

5. The barricade of claim 1, wherein the primary, first, and second cells are formed from multiple sheets of barricading fabric.

6. The barricade of claim 5, wherein one of the multiple sheets of barricading fabric is a first sheet defining a first exterior side, a second of the multiple sheets of barricading fabric is a second sheet defining a second exterior side, and a third of the multiple sheets of barricading fabric is a third sheet defining an interior divider coupled to and extending between the first and second exterior sides, wherein the first, second, and third sheets in combination form the primary, first, and second cells, and further wherein the first and second exterior sides have a height and the interior divider has a height less than the height of the first and second exterior sides.

7. The barricade of claim 1, wherein each of the primary, first, and second cells comprise a triangular shape.

8. An adaptable protective barrier, comprising:
a first triangular compartment comprising a first base wall, a first exterior wall, and a first interior wall, each of the first base wall, the first exterior wall, and the first interior wall comprise collapsible barrier fabric, wherein the first triangular compartment has a first orientation and a first apex defined by a first intersection between the first interior wall and the first exterior wall;
a central triangular compartment comprising a central base wall, a proximal wall, and a distal wall, wherein each of the central base wall, the proximal wall, and the distal wall comprise collapsible barrier fabric, wherein the central triangular compartment has a central orientation opposite the first orientation, and further wherein the central base wall has a distal end connected to the distal wall and a proximal end connected to the proximal wall;
a second triangular compartment comprising a second base wall, a second exterior wall, and a second interior wall, wherein each of the second base wall, the second exterior wall, and the second interior wall comprise collapsible barrier fabric, wherein the second triangular compartment has the first orientation and a second apex defined by a second intersection between the second interior wall and the second exterior wall; and
wherein the first interior wall engages the proximal wall, the proximal end engages the first apex, the second interior wall engages the distal wall, and the distal end engages the second apex, and further wherein the collapsible barrier fabric of the central base wall can be collapsed to cause the first triangular compartment and the second triangular compartment to pivot relative to the central triangular compartment.

9. The barrier of claim 8, wherein the central, first, and second triangular compartments are formed from multiple sheets of collapsible barrier fabric.

10. The barrier of claim 9, wherein the multiple sheets of collapsible barrier fabric are mechanically fastened together to form the central, first, and second triangular compartments.

11. The barrier of claim 8, wherein the collapsible barrier fabric comprises a geotextile.

12. The barrier of claim 8, wherein the collapsible barrier fabric is camouflaged.

13. The barrier of claim 8, wherein the first and second base walls are formed from a first sheet of collapsible barrier fabric, the central base wall is formed from a second sheet of collapsible barrier fabric, and the first exterior wall, the first interior wall, the proximal wall, the distal wall, the second exterior wall, and the second interior wall are formed from a third sheet of collapsible barrier fabric, and further wherein the first and second sheets of collapsible barrier fabric have a height and the third sheet of collapsible barrier fabric has a height less than the height of the first and second sheets of collapsible barrier fabric.

14. A method of reconfiguring a protective barrier, comprising:
providing a protective barrier having a first end portion with a first end and a second end portion with a second end, the first end portion aligned along a first axis, the second end portion aligned along a second axis, the protective barrier further comprising a plurality of contiguous cells and each of the plurality of contiguous cells comprises barrier fabric and a cell volume, and further wherein the protective barrier has a length defined between the first end and the second end and a maximum length when the first and second axes are axially aligned; and
collapsing at least one of the plurality of contiguous cells to reduce the volume of the at least one of the plurality of contiguous cells to cause the length of the protective barrier to be less than the maximum length and to cause the first and second axes to be axially misaligned.

15. The method of claim 14, wherein the barrier fabric comprises a geotextile.

16. The method of claim 14, wherein the barrier fabric comprises a camouflage pattern.

17. The method of claim 14, wherein each of the plurality of contiguous cells has a triangular shape.

18. The method of claim 14, wherein each of the plurality of contiguous cells has a rectangular shape.

19. The method of claim 14, further comprising:
filling at least one of the plurality of contiguous cells with a particulate fill material.

20. The method of claim 14, wherein the plurality of contiguous cells are formed from multiple sheets of barrier fabric.
